(19) United States
(12) Patent Application Publication
(10) Pub. No.: US 2014/0300470 A1
(43) Pub. Date: Oct. 9, 2014

(54) MONITORING A GRABBING MECHANISM

(71) Applicant: Anvil Attachments, Slaughter, LA (US)

(72) Inventor: Shane Toncrey, Prairieville, LA (US)

(73) Assignee: Anvil Attachments, Slaughter, LA (US)

(21) Appl. No.: 14/248,785

(22) Filed: Apr. 9, 2014

Related U.S. Application Data
(60) Provisional application No. 61/810,095, filed on Apr. 9, 2013.

(51) Int. Cl. G08B 23/00

(52) U.S. Cl. CPC G08B 23/00
USPC 340/539.22

(57) ABSTRACT

A system and method for monitoring a grabbing mechanism is described herein. The system includes a sensor interface to interface with at least one of a plurality of sensors associated with the grabbing mechanism; a monitoring unit to monitor data from the at least one of the plurality of sensors; and a communication unit to communicate the monitored data with a remote electronic system via a network connection.

### CLAIM OF PRIORITY

This patent application claims priority to U.S. Provisional Application No. 61/810,095, filed Apr. 9, 2013, entitled “Monitoring a Grabbing Mechanism.” This application contains the entirety of U.S. Patent Application No. 61/810,095.

### BACKGROUND

In the realm of large-sized equipment (such as construction equipment), various devices may be attached or fixed to the large-sized equipment in order to aid in the process of performing certain tasks. Thus, an operator may control these various devices remotely to perform specific tasks. The large-sized equipment may be implemented with the ability to move from a first location to a second location.

One such device that may be attached to large-sized equipment is a device with a grabbing mechanism. Via the grabbing mechanism, the operator may move or pickup soil or other construction debris. Alternatively, the grabbing mechanism may be used to move cargo, such as large shipping crates from a first point to a second point (i.e. from a cargo ship to a dock).

Various different types of devices may be implemented in order to accomplish the grabbing. For example, a clamshell bucket may be employed. A clamshell bucket is a claw-like apparatus with the ability use both edges to grip material, and subsequently move material from a first point to a second point.

Often times, the operator of the grabbing mechanism may not use the grabbing mechanism in an optimal or beneficial way. For example, the operator may manipulate the grabbing mechanism in a way that causes damage to the grabbing mechanism, lessens the lifetime of the grabbing mechanism, or performs the task associated with the grabbing mechanism in a sub-optimal fashion.

In these cases, the owner of the large-sized equipment associated with the grabbing mechanism may not be cognizant of the operator's mishandling of the grabbing mechanism until after the fact. Thus, the owner may discover the grabbing mechanism is damaged, or realize the task performed by the grabbing mechanism was performed in a poor fashion.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example system for monitoring a grabbing mechanism.

FIG. 3 Illustrate an example of various sensors that may interface with sensor interface of FIG. 2.

FIG. 4 illustrates an example method for monitoring a grabbing mechanism.

FIGS. 5(a) and 5(b) illustrate an example of the system shown in FIG. 2.

FIG. 6 illustrates an example table that may be sourced from the setting store of FIG. 2.

### SUMMARY

A grabbing mechanism may be monitored by affixing sensors onto the grabbing mechanism, monitoring the output of the affixed sensors, processing if the monitored outputs are within a specific range, and transmitting the monitoring, or indications that the monitored outputs are not within the specific ranges. The transmitting may occur over wireless techniques to various devices equipped with data reception.

### DETAILED DESCRIPTION

A grabbing mechanism may be damaged, or operated in a sub-optimal fashion. This may be due to the grabbing mechanism being operated in ways that do not lead to beneficial results, or alternatively, cause the grabbing mechanism to become damaged due to improper operation. In the absence of any sort of monitoring, an owner of the grabbing mechanism may have no knowledge of this improper handling until after the fact, i.e. when the grabbing mechanism is returned in a damaged state.

Disclosed herein are examples of methods and systems for monitoring a grabbing mechanism by utilizing sensor that communicate through wired, wireless, telemetric and audio/visual sensory techniques dynamically during the operation of the grabbing mechanism. Further, because the grabbing mechanism is monitored, the data associated with the grabbing mechanism may be logged in an external site, such as a centralized server, and viewed and reviewed at a later time.

Thus, by providing feedback in a dynamic fashion, an owner of the grabbing mechanism may be alerted to improper or sub-optimal handling of the grabbing mechanism. In this way, the owner may, through either manual communication or an automatic system, alert the operator of the grabbing mechanism to halt the improper handling.

Additionally, through the monitoring of the grabbing mechanism, various other parameters may be recorded and viewed for the purpose of proactively improving the working of the unit. For example, the grabbing mechanism may be monitored by viewing fuel levels, engine temperatures and the like to ensure that the operator makes adjustments to optimally use the equipment.

Additionally, because the grabbing mechanism is being monitored via sensors, the data associated with the operation of the grabbing mechanism may be transmitted to an external server, stored in a human-readable fashion, and reviewed at a later time. In this way, the owner of the grabbing mechanism may be cognizant of trends associated with the operation of the grabbing mechanism that lead to certain performances (such as damages to the machinery or sub-optimal operation).

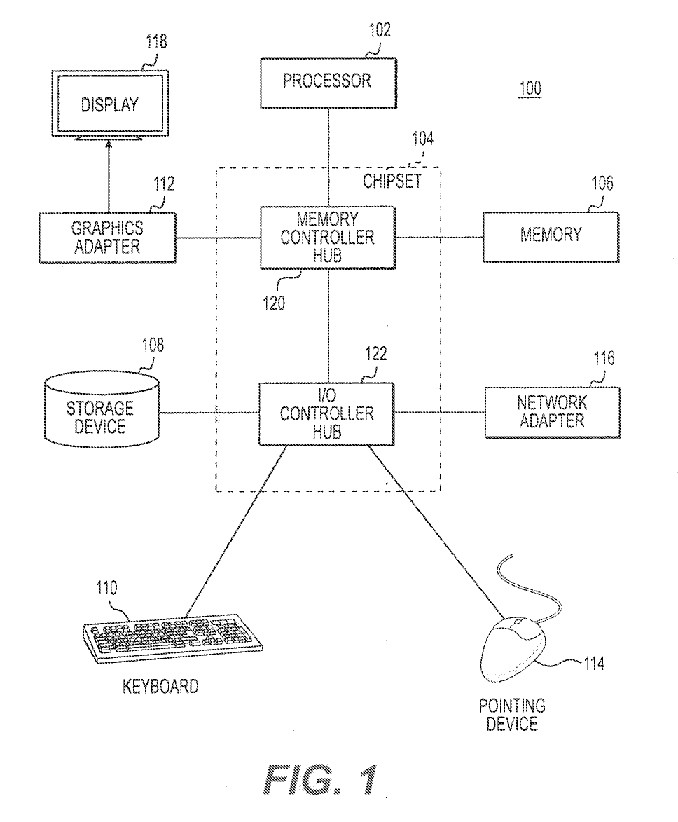

FIG. 1 is a diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer system 100. The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a video corpus, such as a hard disk, solid state memory or storage device, might be stored in a distributed database system comprising multiple blade servers working together to provide the functionality described herein. The computer 100 may be implemented without some of the components described above, such as keyboards 110, graphics adapters 112, and displays 118.

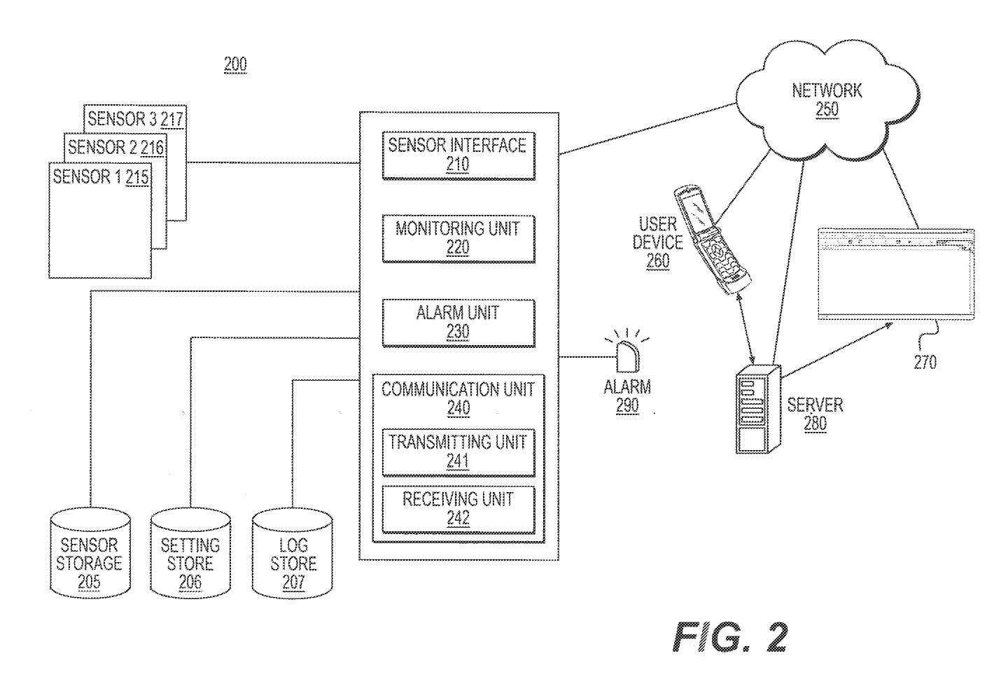

FIG. 2 illustrates an example system for monitoring a grabbing mechanism 200. The system 200 may be implemented on a device such as computer 100. The sensor 200 includes a sensor interface 210, a monitoring unit 220, an alarm unit 230, and a communication unit 240.

The system 200 communicates, via the communication unit 240, to a network 250. The network 250 may be any sort of communication network, such as local area networks (LAN), wide area networks (WAN), telephonic networks, for example. Via the network 250, the system 200 may communicate with a user device 260, a web site 270, and a server 280, based on the implementation of system 200.

The system 200 may be implemented on the grabbing mechanism (not shown). Thus, the system 200 may be directly wired to various sensors, such as sensor 1 215, sensor 2 216, and sensor 3 217. The actual sensors implemented may be customizable based an implementation of system 200 chosen. Several options of sensors used in conjunction with system 200 are described herein, however, one of ordinary skill may implement system 200 with any combination of the sensors described along with sensors known in the art.

Alternatively, system 200 may interact directly with a sensor computer (not shown), that interacts with various sensors associated with the grabbing mechanism (not shown). In another example, system 200 may wirelessly communicate to the various sensors through a wireless communication technique.

In FIG. 2, a sensor database 205 a setting store 206 and a log store 207 are shown. The elements are persistent stores, such as storage device 108. The sensor database 205, the setting store 206 and the log store 207 are shown in FIG. 2 as discrete elements, however, the elements may be implemented as integrated with system 200.

The sensor interface 210 communicates to the various sensors, such as sensor 1 215, sensor 2 216, sensor 3 216, for example. The sensor interface 210 may access a sensor database 205 to ascertain which sensors are interfaced with. The sensor database 205 may be updated by an implementer of system 200 directly or through network 250.

The sensor interface 210 may interface with the various sensors through techniques associated with the communication capabilities with each respective sensor. For example, certain sensors may be equipped with serial wire connections, while other sensors may communicate through a short-range communication technique. The knowledge of how to communicate to the various sensors may also be stored in the sensor database 205.

The monitoring unit 220 samples the sensors interfaced via the sensor interface 210 based on a predetermined interval stored in the setting store 206. Thus, for each predetermined interval, the monitoring unit 220 records an output associated with each interfaced sensor. The monitoring unit 220 may store each output per time in the log store 207. The predetermined interval may be set for each sensor interfaced with, respectively.

The alarm unit 230 retrieves predetermined acceptable ranges for each of the interfaced sensors from the setting store 206, and correlates the predetermined acceptable ranges with the data stored in the log store 207. Thus, if a particular sensor, such as sensor 1 215, records a setting outside a certain acceptable range, the alarm unit 230 triggers an alarm 290 to indicate that the sensed item is not within the acceptable range. The alarm unit 290 may be any device capable of alerting a user of the grabbing mechanism that the sensed item is not within an acceptable range, such as a light, a sound indication, or the like.

The communication unit 240 includes a transmitting unit 241 and a receiving unit 242. The transmitting unit 241 transmits data stored in the log store 207, via network 250, to various third-parties situated remotely from the grabbing mechanism. For example, the transmitting unit 241 may transmit the data to a server 280, or a user device 260 (either directly or via the server 280). Alternatively, or in addition to, the web site 270 (or any sort of application program interface, such as a mobile application) may retrieve the data from the server 280 for presentation to a third-party.

The receiving unit 242 may retrieve, via network 250, various commands and updates to the system 200. For example, the receiving unit 242 may receive updates to the sensor database 205 and setting store 206 based on updated demands. Thus, the predefined settings and ranges may be updated dynamically and remotely based on updated information.

Alternatively, or in addition to, the receiving unit 242 may also serve to disable or limit the operation of the grabbing mechanism. For example, if the system 200 detects, via any of the sensors, that the grabbing mechanism is falling outside one of the predetermined ranges, the system 200 may receive, via the receiving unit 242 a command to halt or limit operation of the grabbing mechanism.

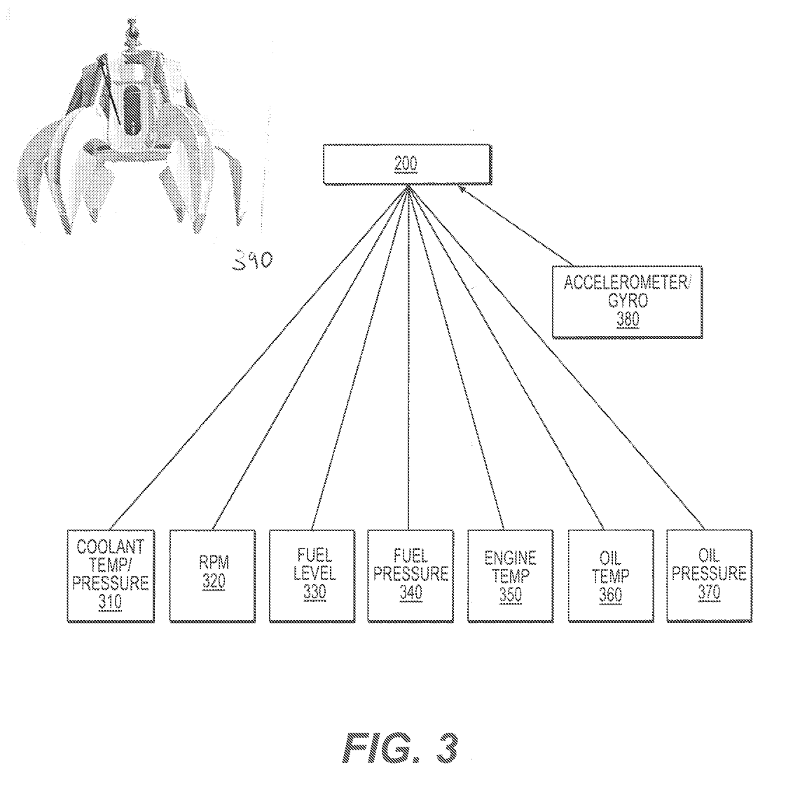

FIG. 3 Illustrate an example of various sensors that may interface with sensor interface 210. The sensors shown in FIG. 3 are implemented with a grabbing mechanism, and may be used by an implementer of system 200 to determine whether the grabbing mechanism is being used improperly or sub-optimally.

For example, the following sensors may include a coolant temperature/pressure sensor 310, a revolutions per minute (RPM) sensor 320, a fuel level sensor 330, a fuel pressure sensor 340, an engine temperature sensor 350, an oil temperature sensor 360, an oil pressure sensor 370, and an accelerometer/gyro sensor 380. The accelerometer/gyro sensor 380 is shown as one unit; however, one of ordinary skill in the art may implement the sensors as discrete units. Each of these sensors may be placed on, or provided in conjunction with, the system 200 or on a grabbing mechanism associated with the system 200.

The various sensors may be incorporated and placed on various portions of a grabbing mechanism 390 shown. The grabbing mechanism 390 is merely exemplary, and other types of grabbing devices may be implemented with system 200.

For example, a global positioning satellite (GPS) sensor may be implemented as one of the sensors attached to the grabbing mechanism 390. Accordingly, the data communicated to the user device 260 may be the position and location of the grabbing mechanism 390.

In another example, a load cell sensor may be attached to the grabbing mechanism 390. The load cell sensor measures the weight of each load grabbed by the grabbing mechanism. Accordingly, a remotely monitored data associated with grabbing mechanism 390 may aid in determining how efficient the grabbing mechanism 390 is operating. Further, an implementer of system 200 may employ the GPS sensor and the load cell sensor to further improve an efficiency measurement associated with the grabbing mechanism 390.

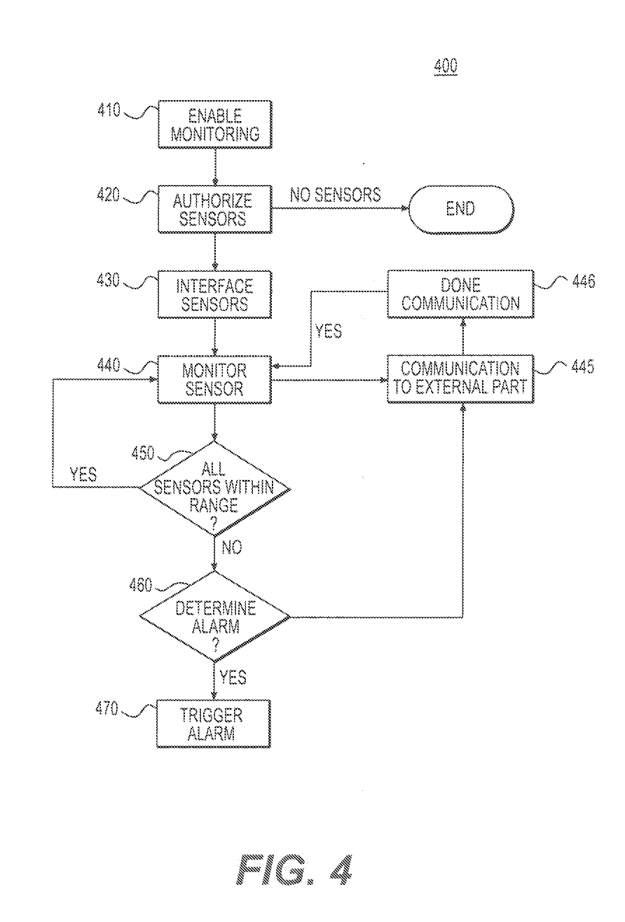

FIG. 4 illustrates an example method 400 for monitoring a grabbing mechanism. The method 400 may be implemented on a system such as system 200.

In operation 410, a mode to enable monitoring of a grabbing mechanism may be entered into. The mode to enable monitoring may be preset, through a manual operation available via the grabbing mechanism (i.e. asserting a switch, or the like). Alternatively, a command may be asserted, and transmitted wirelessly to the grabbing mechanism.

In operation 420, an identification of sensors associated with the grabbing mechanism commences. Thus, the employer of method 420 becomes cognizant of sensors available to monitor. If there are no sensors, method 400 proceeds to end.

In operation 430, the sensors identified are interfaced with. The interfacing may occur in a fashion suitable for each respective sensor. For example, certain sensors may be serially wired to the system 200, while other sensors may communicate with a short-range communication technique.

In operation 440, the sensors are monitored at various predetermined intervals. The predetermined interval used to monitor each sensor may be selected respectively per sensor. The monitoring results may be communicated to various externals sources in operation 445. In operation 446, after communicating, the method 400 may return to a state of monitoring the sensors (operation 440).

In operation 450, as a result of the monitoring performed in operation 440, a determination may be made if the various sensors are within a predefined range. If yes, the method 400 may remain in the state of operation 440.

If a determination is made that one, some or all of the sensors are not within the predefined range, the method 400 proceeds to operation 460. In operation 460, a determination is made to signify an alarm. The alarm may be any sort of audio, visual or combination of cues to an operator of the grabbing mechanism.

If a determination is made to signify an alarm, the alarm is triggered in operation 470. Alternatively, or in addition to, the indication that at least one of the sensor is not within a predefined range may be communicated to an external source (such as the external source communicated to in operation 445).

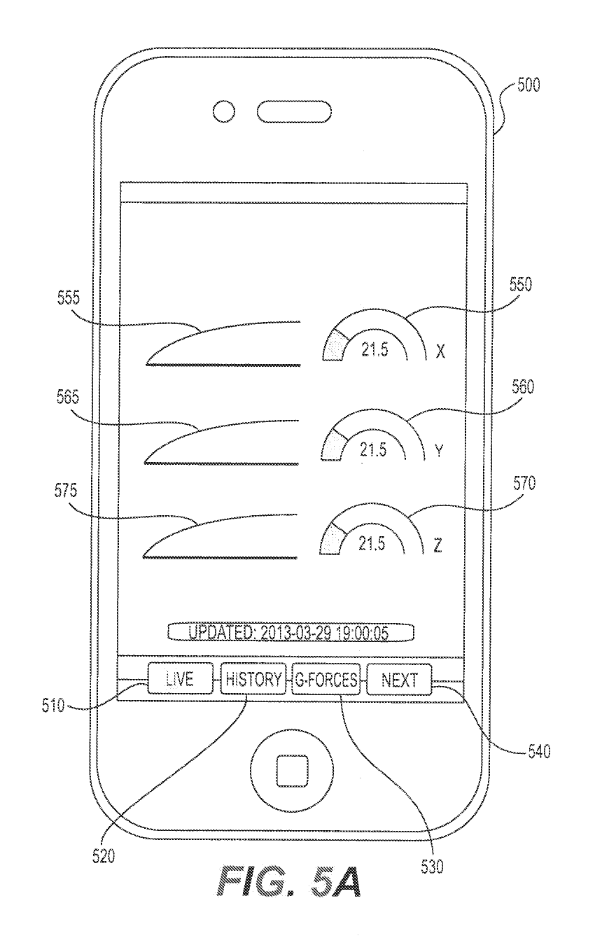

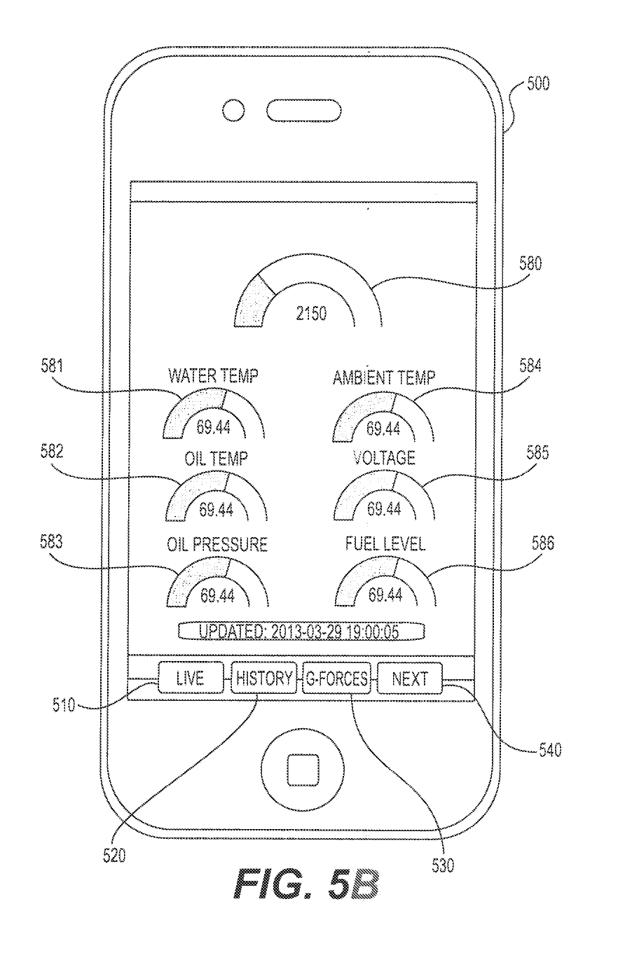

FIGS. 5(a) and 5(b) illustrate an example of the system 200 and the method 400 being implemented with a grabbing mechanism. In both FIGS. 5(a) and 5(b), a user device 500 is shown (which may correspond to user device 260). In the example shown, the user device 500 is a standard smart phone. Alternatively, the user device 500 may be any sort of personal device, such as a tablet, personal computer, or the like.

Referring to FIG. 5(a), four different modes are presented: a live mode 510, a history mode 520, g-force mode 530 (to display monitored readings associated with g-forces), and a next mode 540 (to display additional sensor readings). These modes are exemplary, and any combination of the modes shown, along with other modes, may be presented to the user.

Further, various parameters associated with the XYZ Tilt operation are also presented, including the X tilt 550 (and a log over time 555), the Y tilt 560 (and a log over time 565), and the Z tilt 570 (and a log over time 575). The XYZ Tilt may correspond to the movement of the grabbing mechanism through the various dimensions monitored.

The live mode 510 may present the user with real-time readings. Thus, if live mode 510 is asserted, the user may observe the operation in real-time, as the grabbing mechanism is being operated.

The history mode 520 may present the user with historical readings associated with the monitoring of the grabbing mechanism. In regards to user device 500 as shown in FIG. 5(a), both the historical data and real-time data are presented.

Referring to FIG. 5(b), another display screen is shown associated with user device 500. For example, if the operator of user device 500 asserts the next mode 540 from the display shown in FIG. 5(a), the operator may be presented with the display shown in FIG. 5(b).

Thus, various monitored sensor readings may be displayed (for example, the monitored readings may correspond to the sensors presented in FIG. 3). For example, the user device 500 may present sensor readings for an engine RPM 580, water temperature 581, oil temperature 582, oil pressure 583, ambient temperature 584, voltage 585, and fuel level 586.

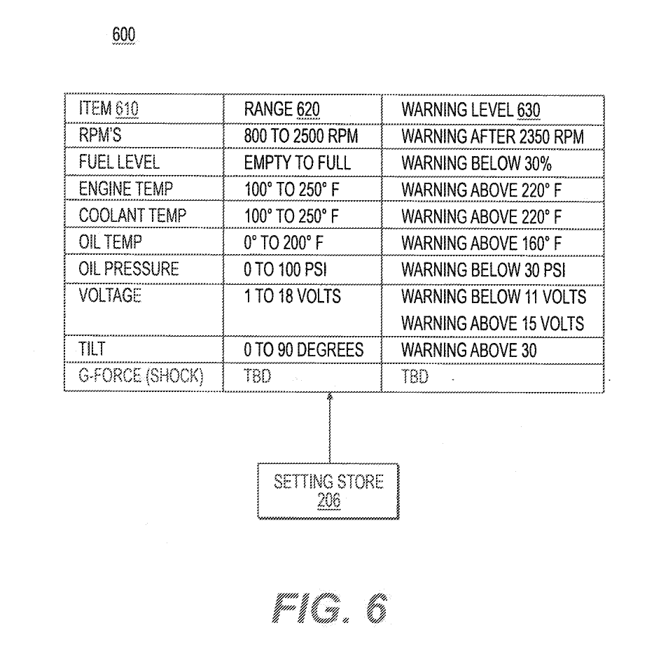

FIG. 6 illustrates an example table that may be sourced from the setting store 206. FIG. 6 includes a table 600, an item field 610, a range field 620, and a warning level field 630.

The item field 610 may correspond to the various sensors presented in FIG. 3. The range field 620 may correspond to the various ranges that are deemed acceptable for the corresponding sensed item. The warning level field 630 may correspond to when an alarm is indicated based on the corresponding sensed item going over or below a specific predefined value.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 4. The disclosed devices, components, and systems contemplate using or implementing any suitable technique for performing the steps illustrated in these figures. Thus, FIG. 4 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

We claim:

1. A system for monitoring a grabbing mechanism, comprising:
a data store comprising a computer readable medium storing a program of instructions for the monitoring;
a processor that executes the program of instructions;
a sensor interface to interface with at least one of a plurality of sensors associated with the grabbing mechanism;
a monitoring unit to monitor data from the at least one of the plurality of sensors; and
a communication unit to communicate the monitored data with a remote electronic system via a network connection.

2. The system according to claim 1, further comprising an alarm unit to indicate an alarm in response to the at least one of the plurality of sensors being outside a predetermined range.

3. The system according to claim 2, wherein the at least one of the plurality of sensors is a coolant and temperature sensor for the grabbing mechanism.

4. The system according to claim 2, wherein the at least one of the plurality of sensors is a revolution per minute sensor for the grabbing mechanism.

5. The system according to claim 2, wherein the at least one of the plurality of sensors is a fuel level sensor for the grabbing mechanism.

6. The system according to claim 2, wherein the at least one of the plurality of sensors is a fuel pressure sensor for the grabbing mechanism.

7. The system according to claim 2, wherein the at least one of the plurality of sensors is an engine temperature sensor for the grabbing mechanism.

8. The system according to claim 2, wherein the at least one of the plurality of sensors is an oil temperature sensor for the grabbing mechanism.

9. The system according to claim 2, wherein the at least one of the plurality of sensors is an oil pressure sensor for the grabbing mechanism.

10. The system according to claim 2, wherein the at least one of the plurality of sensors is an accelerometer/gyro sensor for the grabbing mechanism.

11. The system according to claim 2, wherein the at least one of the plurality of sensors is location sensor for the grabbing mechanism.

12. The system according to claim 2, wherein the at least one of the plurality of sensors is load cell sensor for the grabbing mechanism.

13. A method performed on a processor for monitoring a grabbing mechanism, comprising:
interfacing with at least one of a plurality of sensors associated with the grabbing mechanism;
monitoring the data of the at least one of a plurality of sensors; and
communicating to a remote device the monitored data,
wherein at least one of the interfacing, monitoring, or communicating is performed by the processor.

14. The method according to claim 13, further comprising:
receiving an indication that the at least one of the plurality of sensors is outside a predetermined range; and
in response to being outside of the predetermined range, indicating an alarm.

15. The method according to claim 14, wherein the at least one of the plurality of sensors is a coolant and temperature sensor for the grabbing mechanism.

16. The method according to claim 14, wherein the at least one of the plurality of sensors is a revolution per minute sensor for the grabbing mechanism.

17. The method according to claim 14, wherein the at least one of the plurality of sensors is a fuel level sensor for the grabbing mechanism.

18. The method according to claim 14, wherein the at least one of the plurality of sensors is a fuel pressure sensor for the grabbing mechanism.

19. The method according to claim 14, wherein the at least one of the plurality of sensors is an engine temperature sensor for the grabbing mechanism.

20. The method according to claim 14, wherein the at least one of the plurality of sensors is an oil temperature sensor for the grabbing mechanism.

21. The method according to claim 14, wherein the at least one of the plurality of sensors is an oil pressure sensor for the grabbing mechanism.

22. The method according to claim 14, wherein the at least one of the plurality of sensors is an accelerometer/gyro sensor for the grabbing mechanism.

23. The method according to claim 14, wherein the at least one of the plurality of sensors is location sensor for the grabbing mechanism.

24. The method according to claim 14, wherein the at least one of the plurality of sensors is load cell sensor for the grabbing mechanism.

25. A system for remotely receiving monitored data from a grabbing mechanism, comprising:
a data store comprising a computer readable medium storing a program of instructions for the remote receiving;
a processor that executes the program of instructions;
a communication unit to communicate via a network to the grabbing mechanism, the grabbing mechanism being equipped with a wireless communication device;
a graphical user interface (GUI) to present monitored data received via the communication unit from the grabbing mechanism; and
a data logger to store the received monitored data.

26. The system according to claim 25, wherein the GUI is presented as an application on a mobile device.

27. The system according to claim 25, wherein the monitored data corresponds to at least one of a plurality of sensors associated with the grabbing mechanism.
